(19) United States
(12) Patent Application Publication
(10) Pub. No.: US 2025/0323328 A1
(43) Pub. Date: Oct. 16, 2025

(54) BATTERY PACK

(71) Applicants: HYUNDAI MOTOR COMPANY, Seoul (KR); Kia Corporation, Seoul (KR)

(72) Inventors: Gyung Hoon SHIN, Hwaseong-si (KR); Hae Woong JUNG, Hwaseong-si (KR)

(73) Assignees: HYUNDAI MOTOR COMPANY, Seoul (KR); Kia Corporation, Seoul (KR)

(21) Appl. No.: 19/025,169

(22) Filed: Jan. 16, 2025

(30) Foreign Application Priority Data
Apr. 16, 2024 (KR) 10-2024-0050902
Aug. 19, 2024 (KR) 10-2024-0110818

(51) Int. Cl. H01M 10/42; H01M 10/613; H01M 10/6555

(52) U.S. Cl. CPC H01M 10/425; H01M 10/4207; H01M 10/613; H01M 10/6555

(57) ABSTRACT

A battery pack includes two or more battery modules stacked in an upward and downward direction and each thereof including a plurality of battery stacks disposed in a horizontal direction, cooling plates mounted between the two or more battery modules, a base plate mounted below the two or more battery modules and the cooling plates, a power distribution unit (PDU) assembly electrically connected to the battery module, an upper cover member defining a space for accommodating the battery module and the cooling plate, and a grounding unit including one side connected to the PDU assembly, and the other side connected to the cooling plate or the base plate.

### CROSS-REFERENCE TO RELATED APPLICATION

The present application claims priority to Korean Patent Application No. 10-2024-0050902 filed on Apr. 16, 2024, and Korean Patent Application No. 10-2024-0110818 filed on Aug. 19, 2024, the entire contents of which is incorporated herein for all purposes by this reference.

### BACKGROUND OF THE PRESENT DISCLOSURE

### Field of the Present Disclosure

The present disclosure relates to a battery pack, and more particularly, to a battery pack including a structure in which a plurality of battery modules is stacked.

### Description of Related Art

A battery pack mounted in an electric vehicle needs to have a means for effectively cooling a battery. Methods of cooling the batteries may be classified into an air-cooled method and a water-cooled method depending on the types of fluids used to cool the batteries in the battery packs. Among these methods, the water-cooled method may have an excellent cooling effect and thus be applied to a battery pack mounted in a high-performance electric vehicle.

Meanwhile, to improve performance of the battery pack, studies are being conducted about a method of stacking battery modules in the battery pack. The battery pack having a ‘multi-stage structure’ may have a structure in which a plurality of battery modules is stacked in an upward and downward direction, and cooling plates are fitted between the battery modules.

Meanwhile, it is necessary to develop a new grounding structure for a battery pack having a multi-stage structure, the grounding structure being different from that of a battery pack having a single-layer structure.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a novel grounding structure configured for being applied to a battery pack including a multi-stage structure.

To achieve the above-mentioned object, one aspect of the present disclosure provides a battery pack including: two or more battery modules stacked in an upward and downward direction and each thereof including a plurality of battery stacks disposed in a horizontal direction thereof; cooling plates mounted between the two or more battery modules; a base plate mounted below the two or more battery modules and the cooling plates; a power distribution unit (PDU) assembly electrically connected to the battery module; an upper cover member defining a space for accommodating the battery module and the cooling plate; and a grounding unit including one side connected to the PDU assembly, and the other side connected to the cooling plate or the base plate.

The PDU assembly may include a PDU housing defining an external appearance of the PDU assembly, one side of the grounding unit may be connected to the PDU housing, and the other side of the grounding unit may be connected to the cooling plate or the base plate.

The grounding unit may include a first grounding portion including one side connected to the PDU housing, and the other side connected to the cooling plate.

The cooling plates may further include a lowermost end cooling plate additionally mounted between the base plate and the battery module mounted at a lowermost end portion of the battery pack among the two or more battery modules, one side of the first grounding portion may be connected to the PDU housing, and the other side of the first grounding portion may be connected to the lowermost end cooling plate.

The cooling plates may further include an uppermost end cooling plate mounted above the battery module mounted at an uppermost end portion among the two or more battery modules, one side of the first grounding portion may be connected to the PDU housing, and the other side of the first grounding portion may be connected to the uppermost end cooling plate.

The first grounding portion may include: a first portion of the first grounding portion including one side connected to the uppermost end cooling plate, and the other side connected to the lowermost end cooling plate; and a second portion of the first grounding portion including one side connected to the PDU housing, and the other side connected to the uppermost end cooling plate.

The first portion of the first grounding portion may be divided into a plurality of regions, and the plurality of regions of the first portion of the first grounding portion may connect the two cooling plates mounted adjacent to each other in the upward and downward direction of the battery pack.

The plurality of regions, which forms the first portion of the first grounding portion, may be mounted at positions corresponding to one another in the horizontal direction of the battery pack.

The grounding unit may further include a second grounding portion including one side connected to the PDU housing, and the other side connected to the base plate.

The cooling plates may further include an uppermost end cooling plate mounted above the battery module mounted at an uppermost end portion among the two or more battery modules, and the second grounding portion may include: a first portion of the second grounding portion including one side connected to the base plate, and the other side connected to the uppermost end cooling plate; and a second portion of the second grounding portion including one side connected to the PDU housing, and the other side connected to the uppermost end cooling plate.

The first portion of the second grounding portion and the second portion of the second grounding portion may be electrically insulated from the uppermost end cooling plate.

The first portion of the second grounding portion and the second portion of the second grounding portion may be spaced apart from the remaining cooling plates excluding the uppermost end cooling plate among the cooling plates.

The grounding unit may further include an external connection portion including one side connected to the PDU housing and protruding to the outside of the battery pack.

The battery pack may further include: a first connection portion connecting the two battery modules mounted adjacent to each other in the upward and downward direction of the battery pack, in which the first connection portion includes: a first intermediate member mounted between the two battery modules mounted adjacent to each other in the upward and downward direction of the battery pack; and an insertion member mounted to penetrate the first intermediate member and one side of each of the two battery modules mounted adjacent to each other in the upward and downward direction of the battery pack, and in which the insertion member is mounted to be spaced apart from the cooling plate.

The battery module may further include an end cap member mounted to face one side of the battery stack and configured to fix the battery stack, the end cap member may include: an end cap body defining a region facing the battery stack; and an end cap connection region protruding to the outside from the end cap body and mounted to face the first intermediate member in the upward and downward direction of the battery pack, and the insertion member may be mounted to penetrate the first intermediate member and the end cap connection region.

The cooling plates may further include a lowermost end cooling plate additionally mounted between the base plate and the battery module mounted at a lowermost end portion of the battery pack among the two or more battery modules, the first connection portion may further include a bottom insertion member mounted to penetrate the base plate and one side of the battery module mounted at the lowermost end portion, and the bottom insertion member may be mounted to be spaced apart from the lowermost end cooling plate.

According to an exemplary embodiment of the present disclosure, it is possible to apply the novel grounding structure, which is configured for being applied to a battery pack including a multi-stage structure, to the battery pack.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view exemplarily illustrating a battery pack according to an exemplary embodiment of the present disclosure.

FIG. 2 is a perspective view exemplarily illustrating a state in which an upper cover member is removed from the battery pack according to an exemplary embodiment of the present disclosure.

FIG. 3 is a perspective view exemplarily illustrating a coupling structure between a PDU assembly and a portion of a grounding unit of the battery pack according to an exemplary embodiment of the present disclosure.

FIG. 4 is an enlarged top plan view exemplarily illustrating the PDU assembly of the battery pack according to an exemplary embodiment of the present disclosure and surrounding components thereof.

FIG. 5 is a view exemplarily illustrating first grounding portions of the battery pack and surrounding components thereof according to an exemplary embodiment of the present disclosure.

FIG. 6 is an enlarged view exemplarily illustrating a state in which the first grounding portion in FIG. 5 is connected to a cooling plate.

FIG. 7 is an enlarged view exemplarily illustrating a state in which the first grounding portion in FIG. 5 is connected to a PDU housing.

FIG. 8 is a view exemplarily illustrating second grounding portions of the battery pack according to an exemplary embodiment of the present disclosure and surrounding components thereof.

FIG. 9 is an enlarged view exemplarily illustrating a lateral structure of the battery pack according to an exemplary embodiment of the present disclosure.

FIG. 10 is an enlarged view exemplarily illustrating a state in which some surrounding components of an end cap member in FIG. 9 are removed.

FIG. 11 is a cross-sectional view exemplarily illustrating a coupling structure between two battery modules mounted adjacent to each other in an upward and downward direction in the battery pack according to an exemplary embodiment of the present disclosure.

FIG. 12 is a cross-sectional view exemplarily illustrating a coupling structure between a horizontal connection member and the battery module mounted at an uppermost end portion in the battery pack according to an exemplary embodiment of the present disclosure.

FIG. 13 is a cross-sectional view exemplarily illustrating a coupling structure between a base plate and the battery module mounted at a lowermost end portion in the battery pack according to an exemplary embodiment of the present disclosure.

FIG. 14 is a top plan view of the battery pack according to an exemplary embodiment of the present disclosure.

FIG. 15 is an enlarged view exemplarily illustrating a state in which an upper reinforcement member is coupled to an upper portion of the battery module mounted at the uppermost end portion in FIG. 14.

FIG. 16 is a cross-sectional view exemplarily illustrating a coupling structure between a second connection portion and the battery module mounted at the uppermost end portion in FIG. 14.

FIG. 17 is a perspective view for explaining a connection structure between the battery module and the cooling plate in the battery pack according to an exemplary embodiment of the present disclosure.

FIG. 18 is an enlarged perspective view exemplarily illustrating one of reinforcement connection members in FIG. 17.

FIG. 19 is an enlarged perspective view exemplarily illustrating another of the reinforcement connection members in FIG. 17.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, a battery pack according to an exemplary embodiment of the present disclosure will be described with reference to the drawings.

### Battery Pack

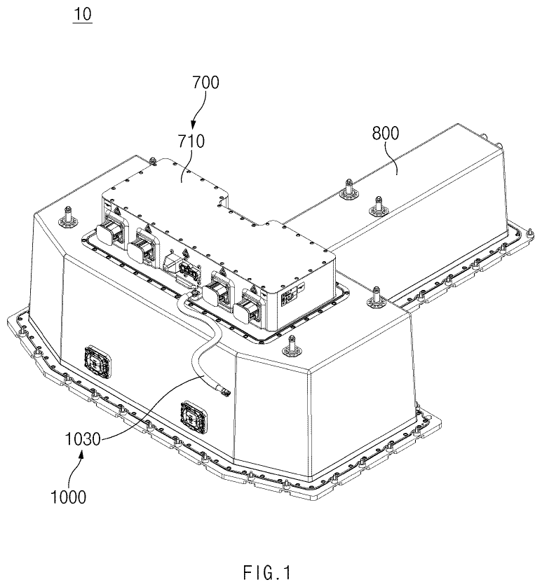

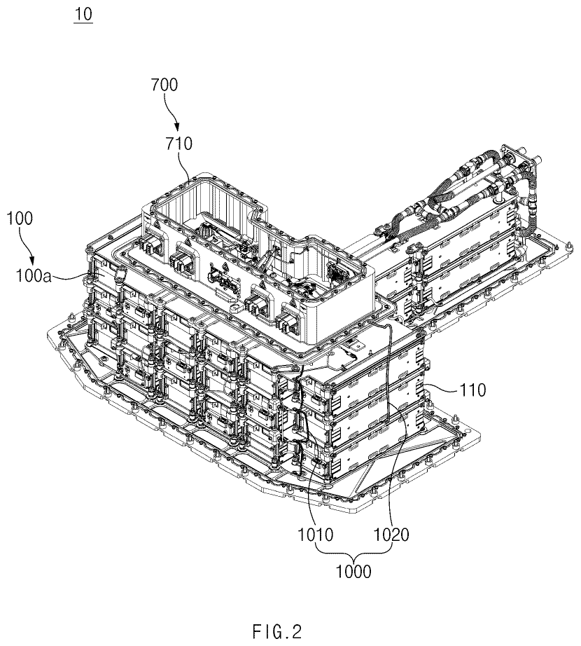

FIG. 1 is a perspective view exemplarily illustrating a battery pack according to an exemplary embodiment of the present disclosure, and FIG. 2 is a perspective view exemplarily illustrating a state in which an upper cover member is removed from the battery pack according to an exemplary embodiment of the present disclosure.

With reference to FIG. 1 and FIG. 2, a battery pack 10 according to an exemplary embodiment of the present disclosure may include battery modules 100 each including a plurality of battery stacks 110 disposed in a horizontal direction of the battery modules 100. The battery stacks 110 may include a structure in which a plurality of batteries are stacked. For example, the above-mentioned battery may be a pouch-type battery. Alternatively, the battery may be a cylindrical battery or an angular battery.

Meanwhile, the battery pack 10 according to an exemplary embodiment of the present disclosure may include a configuration for cooling the battery module 100 by absorbing heat generated from the battery module 100, and discharging the generated heat to the outside of the battery module 100. The battery pack 10 according to an exemplary embodiment of the present disclosure may further include cooling plates 200 mounted at one side of the battery module 100 and configured to cool the battery module 100 thereby. A flow path may be formed in the cooling plates 200, and a cooling fluid may flow along the formed flow path. The fluid flowing along the formed flow path may absorb thermal energy of the battery module 100 while flowing along the flow path of the cooling plates 200, and the fluid may be discharged to the outside from the cooling plates 200 so that the battery module 100 may be cooled by the fluid. As illustrated in FIG. 1 and FIG. 2, the cooling plates 200 may be mounted above and/or below the battery module 100 and configured to receive thermal energy from the battery module 100 by thermal conduction therebetween.

Meanwhile, the battery pack 10 according to an exemplary embodiment of the present disclosure may further include a base plate 400 mounted below the battery module 100. The battery pack 10 according to an exemplary embodiment of the present disclosure may include two or more battery modules 100 each including the plurality of battery stacks 110 disposed in a horizontal direction of the battery modules 100, and the battery modules 100 may be stacked in the upward and downward direction of the battery pack 10. The cooling plates 200 may be mounted between the two or more battery modules. In the instant case, the base plate 400 may be mounted below the battery module 100 mounted at a lowermost end portion of the battery module 100 among the plurality of battery modules 100. The base plate 400 is configured to support loads of the components of the battery pack 10 that include the battery module 100 and the cooling plates 200.

Furthermore, the battery pack 10 according to an exemplary embodiment of the present disclosure may further include electrical insulation tapes provided between the battery modules 100 and the cooling plates 200. For example, the insulation tape may be attached to the battery module 100 and the cooling plates 200. The insulation tape may ensure electrical insulation between the battery module 100 and the cooling plates 200. However, because the thermal conduction between the battery module 100 and the cooling plates 200 needs to be ensured even in the instant case, the insulation tape may be made of a material including electrical insulation while including excellent thermal conduction.

With reference to the drawings, the battery pack 10 according to an exemplary embodiment of the present disclosure may further include a power distribution unit (PDU) assembly 700 electrically connected to the plurality of battery modules 100. The PDU assembly 700 is configured to distribute electric power to a plurality of components in the battery module 100. Furthermore, the PDU assembly 700 may further include a relay member configured to perform control to turn on or off electric power, a fuse member configured to cut off the electric power in an emergency situation, and a battery management system (BMS) configured to diagnose a state of the battery module 100 or a state of the battery stack 110 in the battery module 100. For example, as illustrated in the drawings, the PDU assembly 700 may be mounted to face an upper surface of the cooling plate 200 provided above the battery module 100 positioned at an uppermost end portion of the battery module 100 among the plurality of battery modules 100.

Furthermore, the battery pack 10 according to an exemplary embodiment of the present disclosure may further include an upper cover member 800 configured to define a space for accommodating the battery module 100, the cooling plates 200, the insulation tapes, and the like. The upper cover member 800, together with the base plate 400, may define an internal space of the battery pack 10 and are configured to accommodate main components of the battery pack 10 and seal the internal space from the outside of the upper cover member 800. A lower surface of the upper cover member 800 may be tightly attached and fixed to an upper surface of the base plate 400. Furthermore, a portion of an upper surface of the upper cover member 800 may include an opened region, and the PDU assembly 700 may be accommodated in the opened region.

Meanwhile, in the present specification, the upward and downward direction and the horizontal direction are defined based on the battery pack 10 illustrated in the drawings. However, the upward and downward direction and the horizontal direction may be respectively substituted with and used as a first direction and a second direction, respectively. In the instant case, it should be understood that the first direction and the second direction are perpendicular to each other.

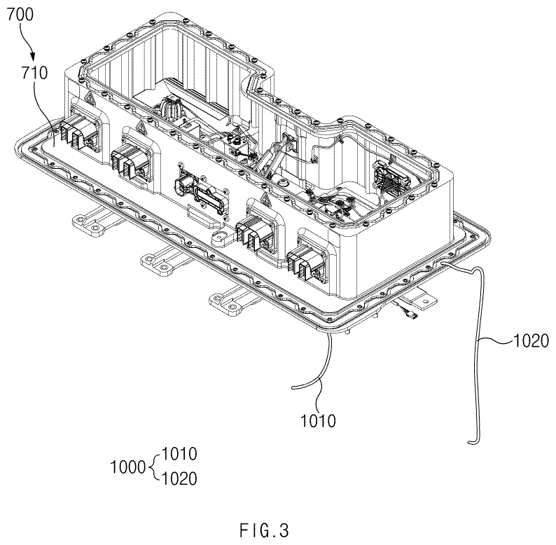

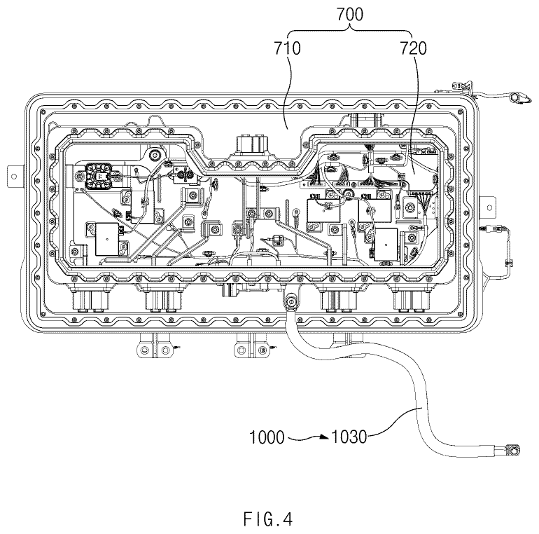

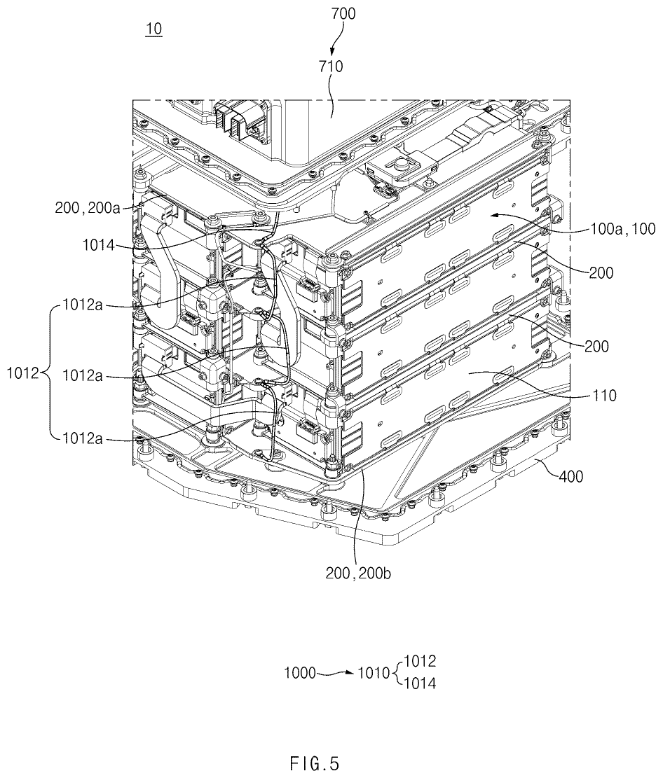

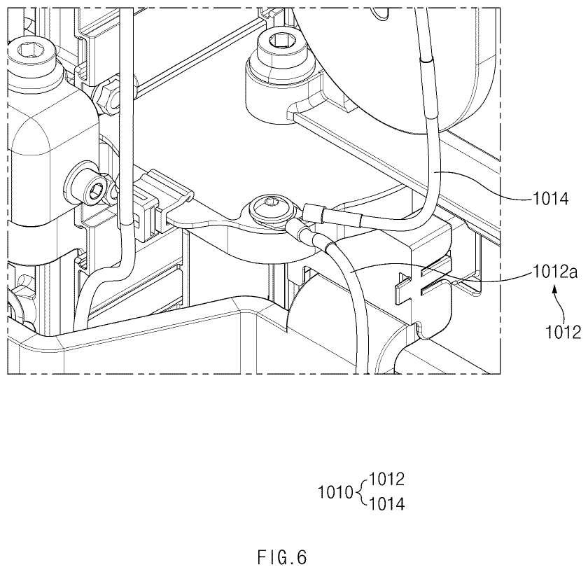

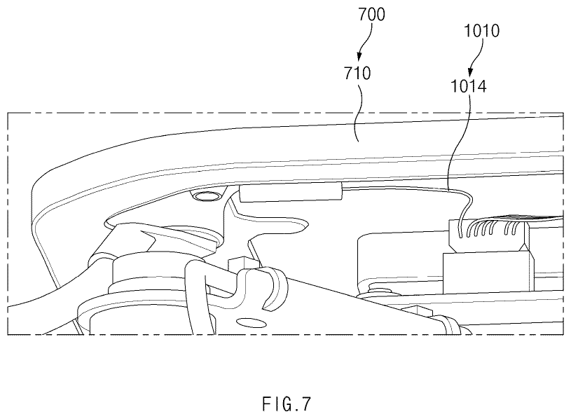

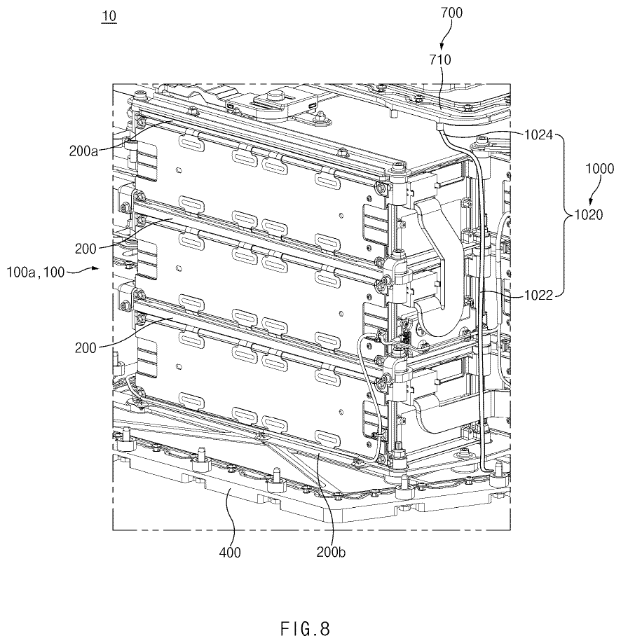

FIG. 3 is a perspective view exemplarily illustrating a coupling structure between the PDU assembly 700 and a portion of a grounding unit of the battery pack 10 according to an exemplary embodiment of the present disclosure, and FIG. 4 is an enlarged top plan view exemplarily illustrating the PDU assembly of the battery pack 10 and surrounding components thereof according to an exemplary embodiment of the present disclosure. FIG. 5 is a view exemplarily illustrating first grounding portions of the battery pack 10 according to an exemplary embodiment of the present disclosure and surrounding components thereof, and FIG. 6 is an enlarged view exemplarily illustrating a state in which the first grounding portion 1010 in FIG. 5 is connected to a cooling plate 200. FIG. 7 is an enlarged view exemplarily illustrating a state in which the first grounding portion 1010 in FIG. 5 is connected to a PDU housing, and FIG. 8 is a view exemplarily illustrating second grounding portions of the battery pack 10 according to an exemplary embodiment of the present disclosure and surrounding components thereof.

Meanwhile, as illustrated in FIGS. 3 to 8, the battery pack 10 according to an exemplary embodiment of the present disclosure may further include a grounding unit including one side configured to discharge a leakage current, which is generated in the battery pack 10, to the outside of the battery pack 10. The battery pack 10 may further include a grounding unit 1000 including one side connected to the PDU assembly 700, and the other side connected to the cooling plates 200 or the base plate 400. For example, the grounding unit 1000 may be electrically connected to the cooling plates 200 and the base plate 400.

The PDU assembly 700 may include a PDU housing 710 configured to define an external appearance of the PDU assembly 700. One side of the grounding unit 1000 may be electrically connected to the PDU housing 710, and the other side of the grounding unit 1000 may be electrically connected to the cooling plates 200 or the base plate 400. Hereinafter, a detailed configuration of the grounding unit 1000 will be described in detail.

As illustrated in FIG. 5, FIG. 6 and FIG. 7, the grounding unit 1000 may include a first grounding portion 1010 including one side electrically connected to the PDU housing 710, and the other side electrically connected to the cooling plates 200. The cooling plates 200 may further include a lowermost end cooling plate 200b additionally mounted between the base plate 400 and the battery module 100 mounted at the lowermost end portion among the two or more battery modules 100. One side of the first grounding portion 1010 may be electrically connected to the PDU housing 710, and the other side of the first grounding portion 1010 may be electrically connected to the lowermost end cooling plate 200b.

Meanwhile, the cooling plates 200 may further include an uppermost end cooling plate 200a mounted above the battery module 100 mounted at the uppermost end portion among the two or more battery modules 100. In the instant case, one side of the first grounding portion 1010 may be connected to the PDU housing 710, and the other side of the first grounding portion 1010 may be connected to the uppermost end cooling plate 200a. That is, the first grounding portion 1010 may be electrically connected to the PDU housing 710, the uppermost end cooling plate 200a, and the lowermost end cooling plate 200b.

Meanwhile, the first grounding portion 1010 may be divided into a plurality of portions. The first grounding portion 1010 may include a first portion 1012 of the first grounding portion 1010 including one side electrically connected to the uppermost end cooling plate 200a and the other side electrically connected to the lowermost end cooling plate 200b, and a second portion 1014 of the first grounding portion 1010 including one side electrically connected to the PDU housing 710 and the other side electrically connected to the uppermost end cooling plate 200a. Therefore, the first portion 1012 of the first grounding portion 1010 and the second portion 1014 of the first grounding portion 1010 may be connected to each other on the uppermost end cooling plate 200a.

With reference to FIG. 5, FIG. 6 and FIG. 7, the first portion 1012 of the first grounding portion 1010 may be divided into a plurality of regions 1012a. In the instant case, the plurality of regions 1012a of the first portion 1012 of the first grounding portion 1010 may connect the two cooling plates 200 mounted adjacent to each other in the upward and downward direction of the battery pack 10. The plurality of regions 1012a, which forms the first portion 1012 of the first grounding portion, may correspond to one another in the horizontal direction of the battery pack 10. It may be understood that the plurality of regions 1012a substantially overlap one another when the battery pack 10 is viewed from above.

Meanwhile, with reference to FIGS. 3, 4, and 8, the grounding unit 1000 of the battery pack 10 according to an exemplary embodiment of the present disclosure may further include a second grounding portion 1020 including one side electrically connected to the PDU housing 710, and the other side electrically connected to the base plate 400. The second grounding portion 1020 may be mounted to be physically spaced apart from the first grounding portion 1010.

In the instant case, the second grounding portion 1020 may include a first portion 1022 of the second grounding portion 1020 including one side electrically connected to the base plate 400 and the other side connected to the uppermost end cooling plate 200a, and a second portion 1024 of the second grounding portion 1020 including one side electrically connected to the PDU housing 710 and the other side connected to the uppermost end cooling plate 200a. Therefore, the first portion 1022 of the second grounding portion 1020 and the second portion 1024 of the second grounding portion 1020 may be connected to each other on the uppermost end cooling plate 200a.

However, unlike the first grounding portion 1010, the second grounding portion 1020 may be connected to and electrically insulated from the uppermost end cooling plate 200a. The first portion 1022 of the second grounding portion 1020 and the second portion 1024 of the second grounding portion 1020 may be connected to and electrically insulated from the uppermost end cooling plate 200a. Furthermore, the first portion 1022 of the second grounding portion 1020 and the second portion 1024 of the second grounding portion 1020 may be spaced apart from the remaining cooling plates excluding the uppermost end cooling plate 200a among the cooling plates 200. It may be understood that the second grounding portion 1020 is not connected to the remaining cooling plates 200 excluding the uppermost end cooling plate 200a.

Meanwhile, the grounding unit 1000 may further include an external connection portion 1030 including one side electrically connected to the PDU housing 710, and the other side connected to the outside of the battery pack 10. The external connection portion 1030 may be configured to discharge leakage currents, which are accumulated in the PDU housing 710, to the outside of the battery pack 10 through the first grounding portion 1010 and the second grounding portion 1020. The external connection portion 1030 may protrude to the outside of the battery pack 10. In case that the battery pack 10 according to an exemplary embodiment of the present disclosure is mounted in a vehicle, the other side of the external connection portion 1030 may be connected to another component of the vehicle.

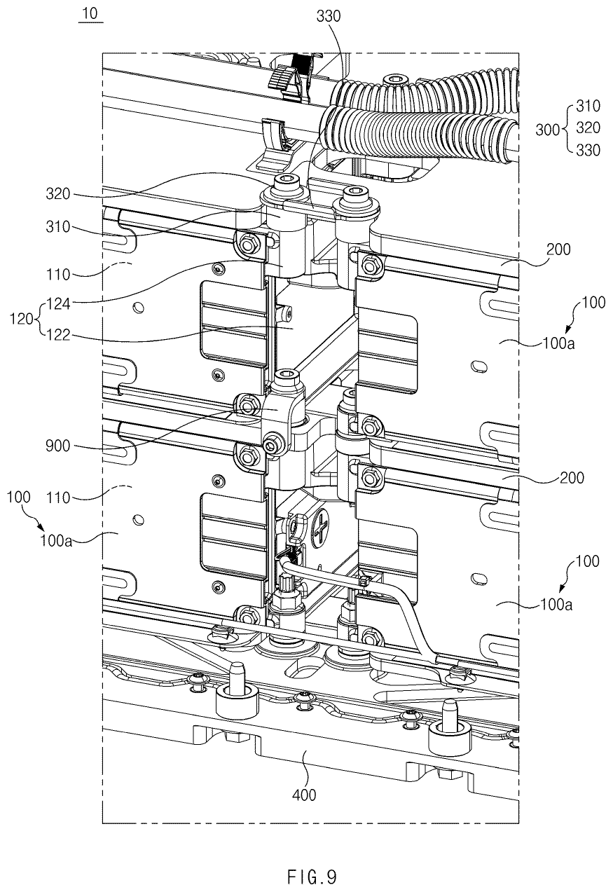

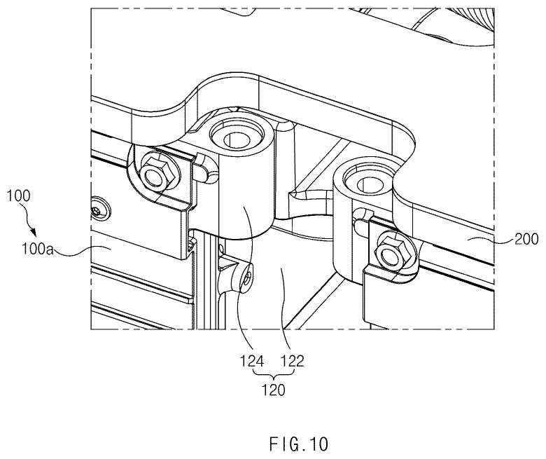

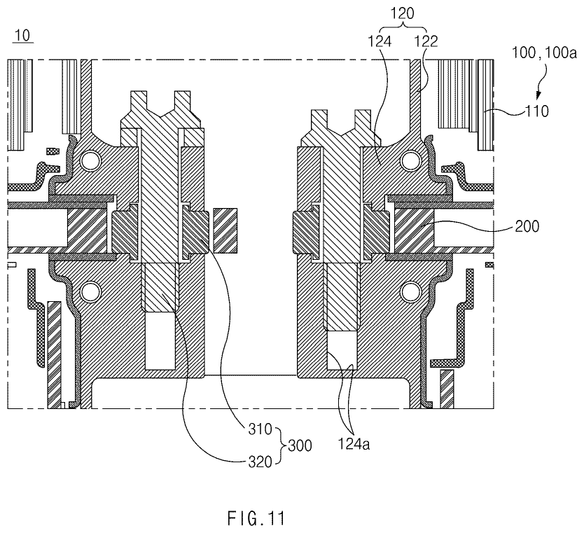

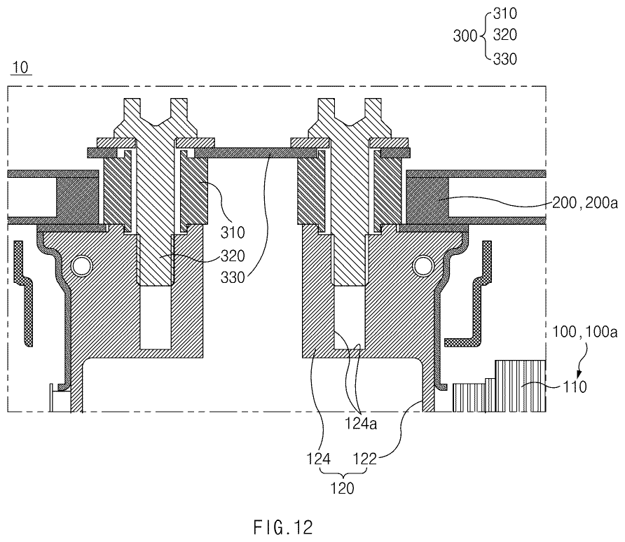

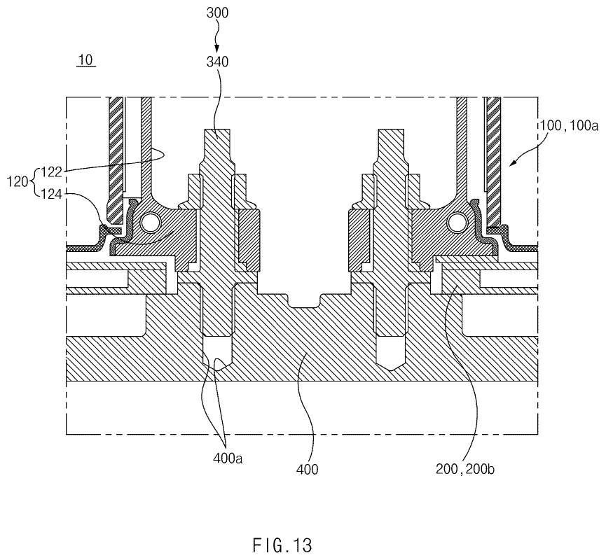

FIG. 9 is an enlarged view exemplarily illustrating a lateral structure of the battery pack according to an exemplary embodiment of the present disclosure, and FIG. 10 is an enlarged view exemplarily illustrating a state in which some surrounding components of an end cap member in FIG. 9 are removed. FIG. 11 is a cross-sectional view exemplarily illustrating a coupling structure between the two battery modules mounted adjacent to each other in the upward and downward direction in the battery pack according to an exemplary embodiment of the present disclosure, and FIG. 12 is a cross-sectional view exemplarily illustrating a coupling structure between a horizontal connection member and the battery module mounted at the uppermost end portion in the battery pack according to an exemplary embodiment of the present disclosure. FIG. 13 is a cross-sectional view exemplarily illustrating a coupling structure between the base plate and the battery module mounted at the lowermost end portion in the battery pack according to an exemplary embodiment of the present disclosure.

Meanwhile, the battery pack 10 according to an exemplary embodiment of the present disclosure may include a first connection portion 300 configured to connect the two battery modules 100 mounted adjacent to each other in the upward and downward direction of the battery pack 10. According to an exemplary embodiment of the present disclosure, the cooling plates 200 may be mounted between the two battery modules 100 adjacent to each other in the upward and downward direction of the battery pack 10. However, the two adjacent battery modules 100 may be directly connected to each other by the first connection portion 300 without using the cooling plates 200.

As illustrated in FIGS. 9 to 11, the first connection portion 300 may include a first intermediate member 310 mounted between the two battery modules 100 mounted adjacent to each other in the upward and downward direction of the battery pack 10. The first intermediate member 310 may be mounted to be in contact with the two battery modules 100 mounted adjacent to each other. Furthermore, the first connection portion 300 may include an insertion member 320 mounted to penetrate the first intermediate member 310 and one side of each of the two battery modules 100 mounted adjacent to each other in the upward and downward direction of the battery pack 10. The insertion member 320 may be one of various members such as studs, nails, and bolts.

Meanwhile, as described above, according to an exemplary embodiment of the present disclosure, the two adjacent battery modules 100 may be directly connected to each other by the first connection portion 300 without using the cooling plates 200. In the instant case, according to an exemplary embodiment of the present disclosure, the insertion member 320 of the first connection portion 300 may be mounted to be physically spaced apart from the cooling plates 200. In the instant case, in comparison with a case in which the two battery modules adjacent to each other in the upward and downward direction are connected indirectly by the cooling plate, the battery pack may be stably manufactured even though the cooling plate does not include a completely flat shape because of a tolerance or the like, and it is possible to prevent physical rigidity of the battery pack from being degraded by a tolerance accumulated by the stacked structure of the battery pack. Meanwhile, with reference to FIGS. 9, 10, 11, and the like, the first intermediate member 310 and the cooling plates 200 may be mounted to overlap each other in the upward and downward direction of the battery pack 10. It may be understood that at least a portion of the first intermediate member 310 and at least a portion of the cooling plates 200 are positioned at the same height in the upward and downward direction of the battery pack 10.

With reference to FIG. 9 and FIG. 10, the battery module 100 may further include an end cap member 120 mounted to face one side of the battery stack 110 and fixed to the battery stack 110. For example, the battery module 100 may include an endplate configured to press the battery stack to provide surface pressure to the battery stack, and the end cap member 120 may be fixedly coupled to the endplate.

Meanwhile, the end cap member 120 may be divided into plurality of regions depending on the function and shape thereof. With reference to FIG. 9 and FIG. 10 and the like, the end cap member 120 may include an end cap body 122 configured to define a region facing the battery stack 110, and an end cap connection region 124 protruding to the outside from the end cap body 122 and mounted to face the first intermediate member 310 in the upward and downward direction of the battery pack 10. In the instant case, the insertion member 320 may be mounted to penetrate the first intermediate member 310 and the end cap connection region 124. Meanwhile, for example, the end cap connection region 124 may protrude from the end cap body 122 in a direction away from the battery stack 110 fixed by the end cap body 122.

Furthermore, the battery module 100 may include a plurality of sub-modules 100a. The battery module 100 may include the plurality of sub-modules 100a each including the plurality of battery stacks 110 and the end cap members 120. That is, the battery stack 110 and the end cap members 120, which are respectively mounted at two opposite sides of the battery stack 110 based on the horizontal direction, may form one sub-module 100a, and the plurality of sub-modules 100a may form one battery module 100. In one battery module 100, the plurality of sub-modules 100a may be mounted to be spaced apart from one another in the horizontal direction of the battery pack 10. Furthermore, in one battery module 100, the end cap member 120 in the sub-module 100a may be mounted to face and spaced apart from the end cap member 120 in another sub-module 100a mounted adjacent to the end cap member 120 in the horizontal direction of the battery pack 10. As illustrated in FIG. 9 and FIG. 10, the end cap connection regions 124 of the end cap members 120 in the two sub-modules 100a mounted adjacent to each other in the horizontal direction may be mounted to protrude in a direction toward each other.

Meanwhile, as described above, the battery pack 10 may include the two or more battery modules 100. Therefore, the two or more battery modules 100 may include an upper battery module, and a lower battery module mounted below the upper battery module and mounted to face the upper battery module. In the instant case, it is noted that the upper battery module and the lower battery module are defined as relative concepts. That is, a certain battery module may be an upper battery module based on a relationship with another battery module positioned below the battery module but be a lower battery module based on a relationship with yet another battery module positioned above the battery module.

In the instant case, with reference to FIGS. 1 to 13, at least some of the plurality of sub-modules 100a in the upper battery module may be mounted to overlap at least some of the sub-modules 100a in the lower battery module in the horizontal direction, and the insertion member 320 of the first connection portion 300 may be mounted to penetrate the end cap connection region 124 of the end cap member 120, which is mounted in the sub-module 100a in the upper battery module, and the end cap connection region 124 of the end cap member 120 mounted in the sub-module 100a in the lower battery module.

Meanwhile, with reference to FIG. 12, the first connection portion 300 may further include a horizontal connection member 330 configured to connect the end cap members 120 mounted in the two sub-modules 100a mounted adjacent to each other in the horizontal direction in one battery module 100. For example, FIG. 12 illustrates a state in which the horizontal connection member 330 connects the end cap members 120 mounted in the two sub-modules 100a mounted adjacent to each other in the horizontal direction in the battery module 100 mounted at the uppermost end portion among the two or more battery modules 100. However, in contrast, the horizontal connection member 330 may be configured to connect the end cap members 120 mounted in another battery module 100 other than the battery module 100 mounted at the uppermost end portion.

With reference to FIG. 12, the insertion member 320, which is mounted to penetrate the end cap member 120 mounted in one of the two sub-modules 100a mounted adjacent to each other in the horizontal direction, may penetrate a first side of the horizontal connection member 330, and the insertion member 320, which is mounted to penetrate the end cap member 120 mounted in the other of the two sub-modules 100a mounted adjacent to each other in the horizontal direction, may penetrate a second side of the horizontal connection member 330. In the instant case, the horizontal connection member 330 is configured to relatively fix the sub-modules 100a mounted adjacent to each other in the horizontal direction in one battery module 100.

Meanwhile, as illustrated in FIG. 11, in case that the insertion member 320 is mounted to penetrate the upper battery module and the lower battery module, a first recessed section 124a may be formed in the end cap connection region 124 of the end cap member 120 mounted in the sub-module 100a in the lower battery module. The first recessed section 124a may include a recessed shape opened upward thereof, and the insertion member 320 may be accommodated in the first recessed section 124a. That is, an upper side of the first recessed section 124a may be formed to be open, and a lower side of the first recessed section 124a may be closed by a lower surface of the first recessed section. In the instant case, a lower end portion of the insertion member 320 may be mounted to be spaced apart from the lower surface of the first recessed section 124a. Accordingly, it may be understood that a predetermined empty space is formed in a space formed by a lower end of the insertion member 320 and the lower surface of the first recessed section 124a.

With reference to FIGS. 9 and 13, the battery pack 10 according to an exemplary embodiment of the present disclosure may further include the base plate 400 configured to define a lower surface of the battery pack 10. The base plate 400 may be mounted below the battery module 100 and the cooling plate 200. Meanwhile, the plurality of cooling plates 200 may also be stacked to correspond to the configuration in which the plurality of battery modules 100 is stacked in the upward and downward direction in the battery pack 10. Furthermore, the first connection portion 300 may further include a bottom insertion member 340 mounted to penetrate a portion of the base plate 400 and one side of the battery module 100 mounted at the lowermost end portion. In the instant case, like the insertion member 320, the bottom insertion member 340 may also be mounted to be spaced apart from the lowermost end cooling plate 200b. That is, the base plate 400 and the battery module 100 mounted at the lowermost end portion may be directly connected to each other by the bottom insertion member 340.

With reference to FIG. 13, a second recessed section 400a including a recessed shape opened upward thereof may be formed in the base plate 400, and the bottom insertion member 340 may be accommodated in the second recessed section 400a. That is, an upper side of the second recessed section 400a may be formed to be open, and a lower side of the second recessed section 400a may be closed by a lower surface of the second recessed section 400a. In the instant case, the lower end portion of the bottom insertion member 340 may be mounted to be spaced apart from a lower surface of the second recessed section 400a. Accordingly, it may be understood that a predetermined empty space is formed in a space formed by a lower end portion of the bottom insertion member 340 and the lower surface of the second recessed section 400a.

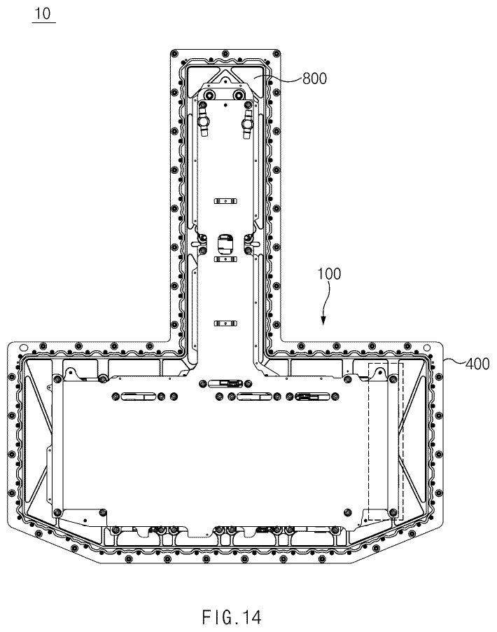

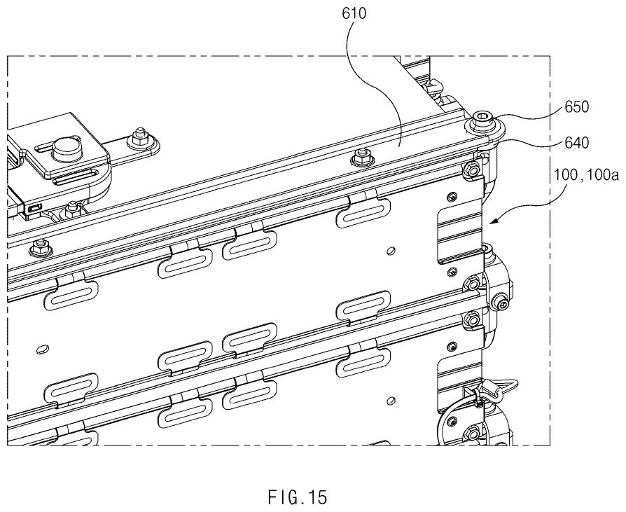

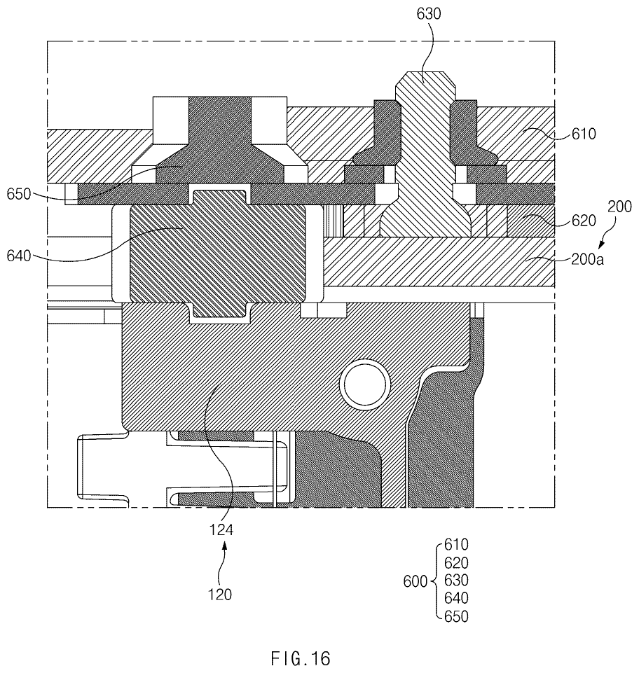

FIG. 14 is a top plan view of the battery pack according to an exemplary embodiment of the present disclosure, and FIG. 15 is an enlarged view exemplarily illustrating a state in which an upper reinforcement member is coupled to an upper portion of the battery module 100 mounted at the uppermost end portion thereof in FIG. 14. FIG. 16 is a cross-sectional view exemplarily illustrating a coupling structure between a second connection portion and the battery module mounted at the uppermost end portion in FIG. 14.

With reference to FIGS. 9, 12, and 14 to 16, the battery pack 10 according to an exemplary embodiment of the present disclosure may further include a second connection portion 600 coupled to one side of the uppermost end cooling plate 200a. The second connection portion 600 may be configured to be a means for connection between the battery stacks 110 in the battery module 100 mounted at the uppermost end portion. The second connection portion 600 may include an upper reinforcement member 610 mounted above the uppermost end cooling plate 200a, a pad member 620 mounted between the upper reinforcement member 610 and the uppermost end cooling plate 200a, and a stud member 630 mounted to penetrate the upper reinforcement member 610 and the uppermost end cooling plate 200a. Meanwhile, the pad member 620 may include or be made of a material including elasticity. That is, according to an exemplary embodiment of the present disclosure, the upper reinforcement member 610 and the uppermost end cooling plate 200a may be fixed by the stud member 630 of the second connection portion 600. The stud member 630 may be mounted to be spaced apart from the pad member 620.

With reference to FIGS. 9, 12, and 14 to 16, the second connection portion 600 may further include components configured to fix the upper reinforcement member 610 and the end cap member 120 mounted in the sub-module 100a of the battery module 100 mounted at the uppermost end portion. The second connection portion 600 may further include a second intermediate member 640 mounted between the upper reinforcement member 610 and the end cap connection region 124 of the end cap member 120 mounted in the sub-module 100a of the battery module 100 mounted at the uppermost end portion among the two or more battery modules, and a coupling member 650 coupled to the second intermediate member 640 and mounted to face the second intermediate member 640 with the upper reinforcement member 610 interposed therebetween. That is, the upper reinforcement member 610 and the battery module 100 mounted at the uppermost end portion may be fixed by the second intermediate member 640 and the coupling member 650 of the second connection portion 600. For example, the first intermediate member 310 and the second intermediate member 640 may be made of the same material.

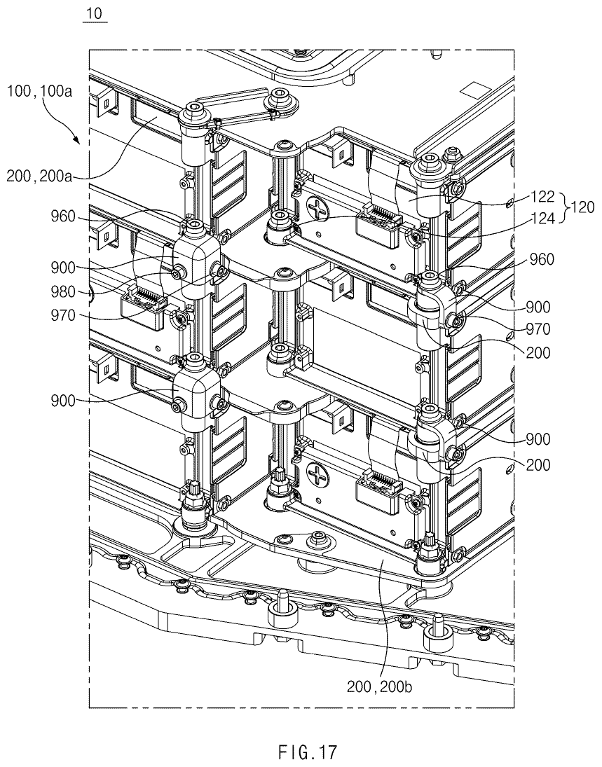

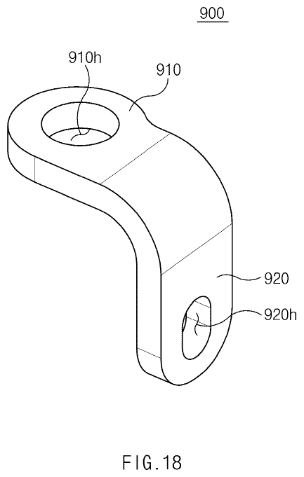

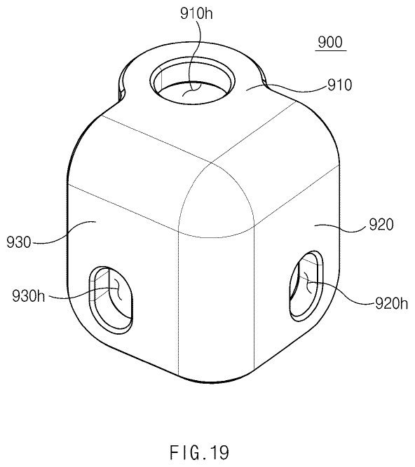

FIG. 17 is a perspective view for explaining a connection structure between the battery module and the cooling plate in the battery pack according to an exemplary embodiment of the present disclosure, and FIG. 18 is an enlarged perspective view exemplarily illustrating one of reinforcement connection members in FIG. 17. FIG. 19 is an enlarged perspective view exemplarily illustrating another of the reinforcement connection members in FIG. 17.

Meanwhile, with reference to FIGS. 17 to 19, the battery pack 10 according to an exemplary embodiment of the present disclosure may further include reinforcement connection members 900 configured to connect and fix the battery modules 100 and the cooling plates 200 mounted adjacent to one another in the upward and downward direction of the battery pack 10. In the instant case, as illustrated in FIG. 17 and FIG. 18, the reinforcement connection member 900 may include a first surface region 910 including one side mounted to face one side of the battery module 100, and a second surface region 920 including one side mounted to face one side of the cooling plates 200. The first surface region 910 and the second surface region 920 may be directly connected to each other. However, as illustrated in FIG. 17 and FIG. 18, the first surface region 910 and the second surface region 920 may be connected to each other indirectly by a curved surface.

The first surface region 910 may be mounted to face one side of the battery module 100 in the upward and downward direction of the battery pack 10, and the second surface region 920 may be mounted to face one side of the cooling plates 200 in the horizontal direction of the battery pack 10.

Meanwhile, the reinforcement connection members 900 mounted in the battery pack may be classified into two or more types of reinforcement connection members depending on the shapes thereof. As illustrated in FIG. 18, the reinforcement connection member 900 may include only the first surface region 910 and the second surface region 920. In contrast, as illustrated in FIGS. 17 and 19, in addition to the first surface region 910 and the second surface region 920, the reinforcement connection member 900 may further include a third surface region 930 including one side mounted to face the other side of the cooling plates 200. The third surface region 930 may be mounted to face the other side of the cooling plates 200 in the horizontal direction of the battery pack 10. Meanwhile, the third surface region 930 may be orthogonal to the second surface region 920, the third surface region 930 may be orthogonal to the first surface region 910, and the first surface region 910 may be orthogonal to the second surface region 920. Meanwhile, the first surface region 910 may be mounted to face one region of the end cap member 120 in the battery module 100 in the upward and downward direction of the battery pack 10. That is, the first surface region 910 may be coupled to the end cap member 120.

Meanwhile, the battery pack according to an exemplary embodiment of the present disclosure may further include a separate coupling member configured to fix the reinforcement connection member 900 to one side of the battery module 100 and the cooling plates 200. The battery pack 10 may further include a first coupling member 960 mounted to penetrate the first surface region 910 of the reinforcement connection member and one side of the battery module 100, a second coupling member 970 mounted to penetrate the second surface region 920 of the reinforcement connection member and one side of the cooling plates 200, and a third coupling member 980 mounted to penetrate the third surface region 930 of the reinforcement connection member and the other side of the cooling plates 200.

Furthermore, a first hole 910h may be formed in a region of the first surface region 910 penetrated by the first coupling member 960, a second hole 920h may be formed in a region of the second surface region 920 penetrated by the second coupling member 970, and a third hole 930h may be formed in a region of the third surface region 930 penetrated by the third coupling member 980. In the instant case, the first hole 910h may include a shape of a circle, whereas the second hole 920h and the third hole 930h may each include a shape in which a width in the upward and downward direction and a width in the horizontal direction are different from each other. A width of the second hole 920h in the upward and downward direction may be greater than a width of the second hole 920h in the horizontal direction, and a width of the third hole 930h in the upward and downward direction may also be greater than the width of the third hole 930h in the horizontal direction of the battery pack 10. This may be to couple the second coupling member 970 and the third coupling member 980 to the cooling plates 200 while coping with a change in position of the cooling plates 200 in the upward and downward direction even though the position of the cooling plates 200 in the upward and downward direction is somewhat changed by tolerances accumulated during the process of manufacturing the battery pack.

Meanwhile, according to an exemplary embodiment of the present disclosure, the first grounding portion 1010 may be configured to discharge a leakage current, which is generated in the battery pack, to the outside through the cooling plates 200 and the PDU housing 710. Therefore, the cooling plates 200 and the PDU housing 710 may be made of an electrically conductive material. For example, the cooling plates 200 and the PDU housing 710 may include or be made of a metal such as aluminum.

In contrast, the second grounding portion 1020 may be configured to discharge a leakage current, which is generated in the battery pack, to the outside through the base plate 400 and the PDU housing 710. The second grounding portion 1020 may be configured to transmit a leakage current, which is generated in the battery module 100, to the PDU housing 710 through the base plate 400. In the instant case, the battery module 100 needs to be electrically connected to the base plate 400 so that a leakage current generated in the battery module 100 is transmitted to the base plate 400.

According to an exemplary embodiment of the present disclosure, the electrical connection between the base plate 400 and the battery module 100 may be performed by the first connection portion 300. The first intermediate member 310, the insertion member 320, the horizontal connection member 330, and the bottom insertion member 340 of the first connection portion 300 may each be made of or include an electrically conductive material. The first intermediate member 310, the insertion member 320, the horizontal connection member 330, and the bottom insertion member 340 may each be made of or include an electrically conductive metallic material. Therefore, according to an exemplary embodiment of the present disclosure, the battery modules 100, which are adjacent to each other in the upward and downward direction of the battery pack 10, may be electrically connected by the first connection portion 300, and the base plate 400 may be electrically connected to the battery module 100 by the first connection portion 300 mounted at the lowermost end so that a leakage current generated in the battery module 100 may be transmitted to the base plate 400 through the first connection portion 300.

Meanwhile, according to an exemplary embodiment of the present disclosure, the leakage current, which is transmitted through the first grounding portion 1010 and the second grounding portion 1020, may be transmitted only to the PDU housing 710 instead of the upper cover member 800. Therefore, unlike the PDU housing 710, the upper cover member 800 may be made of a material with low electrical conductivity. For example, the upper cover member 800 may be made of or include a carbon fiber-reinforced plastic (CFRP) material. The CFRP material may be advantageous in excellent physical rigidity as well as excellent formability.

Furthermore, according to an exemplary embodiment of the present disclosure, the PDU assembly 700 may further include a BMS unit 720 accommodated in the PDU housing 710. In the instant case, regions of the first and second grounding portions 1010 and 1020, which are electrically connected to the PDU housing 710, may be regions of the PDU housing 710 adjacent to the BMS unit 720.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing predetermined embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery pack comprising:
two or more battery modules stacked in an upward and downward direction of the battery pack and each thereof including a plurality of battery stacks disposed in a horizontal direction of the battery pack;
cooling plates mounted between the two or more battery modules;
a base plate mounted below the two or more battery modules and the cooling plates;
a power distribution unit (PDU) assembly electrically connected to the two or more battery modules;
an upper cover member defining a space for accommodating the two or more battery modules and the cooling plates therein; and
a grounding unit including a first side connected to the PDU assembly, and a second side connected to the cooling plates or the base plate.

2. The battery pack of claim 1, wherein the PDU assembly includes a PDU housing defining an external appearance of the PDU assembly, the first side of the grounding unit is connected to the PDU housing, and the second side of the grounding unit is connected to the cooling plates or the base plate.

3. The battery pack of claim 2, wherein the grounding unit includes a first grounding portion including a first side connected to the PDU housing, and a second side connected to the cooling plates.

4. The battery pack of claim 3, wherein the cooling plates further include a lowermost end cooling plate additionally mounted between the base plate and a battery module mounted at a lowermost end portion of the battery pack among the two or more battery modules, the first side of the first grounding portion is connected to the PDU housing, and the second side of the first grounding portion is connected to the lowermost end cooling plate.

5. The battery pack of claim 4, wherein the cooling plates further include an uppermost end cooling plate mounted above a battery module mounted at an uppermost end portion of the battery pack among the two or more battery modules, the first side of the first grounding portion is connected to the PDU housing, and the second side of the first grounding portion is connected to the uppermost end cooling plate.

6. The battery pack of claim 5, wherein the first grounding portion includes:
a first portion including a first side connected to the uppermost end cooling plate, and a second side connected to the lowermost end cooling plate; and
a second portion including a first side connected to the PDU housing, and a second side connected to the uppermost end cooling plate.

7. The battery pack of claim 6, wherein the first portion of the first grounding portion includes a plurality of regions, and the plurality of regions of the first portion of the first grounding portion connects the two cooling plates mounted adjacent to each other in the upward and downward direction of the battery pack.

8. The battery pack of claim 7, wherein the plurality of regions, which forms the first portion of the first grounding portion, is mounted at positions corresponding to one another in the horizontal direction of the battery pack.

9. The battery pack of claim 3, wherein the grounding unit further includes a second grounding portion including a first side connected to the PDU housing, and a second side connected to the base plate.

10. The battery pack of claim 9,
wherein the cooling plates further include an uppermost end cooling plate mounted above a battery module mounted at an uppermost end portion of the battery pack among the two or more battery modules, and
wherein the second grounding portion includes:
a first portion including a first side connected to the base plate, and a second side connected to the uppermost end cooling plate; and
a second portion including a first side connected to the PDU housing,
and a second side connected to the uppermost end cooling plate.

11. The battery pack of claim 10, wherein the first portion of the second grounding portion and the second portion of the second grounding portion are electrically insulated from the uppermost end cooling plate.

12. The battery pack of claim 10, wherein the first portion of the second grounding portion and the second portion of the second grounding portion are spaced apart from remaining cooling plates excluding the uppermost end cooling plate among the cooling plates.

13. The battery pack of claim 9, wherein the grounding unit further includes an external connection portion including one side connected to the PDU housing and protruding to an outside of the battery pack.

14. The battery pack of claim 1, further including:
a first connection portion connecting the two battery modules mounted adjacent to each other in the upward and downward direction,
wherein the first connection portion includes:
a first intermediate member mounted between the two battery modules mounted adjacent to each other in the upward and downward direction of the battery pack; and
an insertion member mounted to penetrate the first intermediate member and one side of each of the two battery modules mounted adjacent to each other in the upward and downward direction of the battery pack, and
wherein the insertion member is mounted to be spaced apart from the cooling plates.

15. The battery pack of claim 14,
wherein the two or more battery modules further includes an end cap member mounted to face one side of a corresponding battery stack and fixing the corresponding battery stack,
wherein the end cap member includes:
an end cap body defining a region facing the corresponding battery stack; and
an end cap connection region protruding to an outside of the battery pack from the end cap body and mounted to face the first intermediate member in the upward and downward direction of the corresponding battery pack, and
wherein the insertion member is mounted to penetrate the first intermediate member and the end cap connection region.

16. The battery pack of claim 15, wherein the first connection portion further includes a horizontal connection member connecting end cap members mounted in the two sub-modules mounted adjacent to each other in the horizontal direction.

17. The battery pack of claim 14,
wherein the cooling plates further include a lowermost end cooling plate additionally mounted between the base plate and a battery module mounted at a lowermost end portion of the battery pack among the two or more battery modules,
wherein the first connection portion further includes a bottom insertion member mounted to penetrate the base plate and one side of the battery module mounted at the lowermost end portion, and
wherein the bottom insertion member is mounted to be spaced apart from the lowermost end cooling plate.

18. The battery pack of claim 1,
wherein the cooling plates further include an uppermost end cooling plate mounted above a battery module mounted at an uppermost end portion of the battery pack among the two or more battery modules, and
wherein the battery pack includes a second connection portion connecting the two or more battery stacks,
wherein the second connection portion includes:
an upper reinforcement member mounted above the uppermost end cooling plate;
a pad member mounted between the upper reinforcement member and the uppermost end cooling plate; and
a stud member mounted to penetrate the upper reinforcement member and the uppermost end cooling plate.

19. The battery pack of claim 1, further including:
a reinforcement connection member to connect the two or more battery modules and the cooling plates mounted adjacent to one another,
wherein the reinforcement connection member includes at least two surface regions and the at least two surface regions includes:
a first surface region including one side mounted to face one side of the two or more battery modules; and
a second surface region including one side mounted to face a first side of the cooling plates.

20. The battery pack of claim 19, wherein the at least two surface regions of the reinforcement connection member further includes a third surface region including one side mounted to face a second side of the cooling plates.
